(19) United States
(12) Patent Application Publication
(10) Pub. No.: US 2013/0289953 A1
(43) Pub. Date: Oct. 31, 2013

(54) SELF-OPTIMIZING, INVERSE ANALYSIS METHOD FOR PARAMETER IDENTIFICATION OF NONLINEAR MATERIAL CONSTITUTIVE MODELS

(71) Applicant: THE UNIVERSITY OF AKRON, (US)

(72) Inventor: GunJin Yun, Copley, OH (US)

(21) Appl. No.: 13/748,905

(22) Filed: Jan. 24, 2013

Related U.S. Application Data
(60) Provisional application No. 61/590,044, filed on Jan. 24, 2012.

(51) Int. Cl. G06F 17/50

(52) U.S. Cl. CPC G06F 17/5018
USPC 703/2

(57) ABSTRACT

A self-optimizing, inverse analysis method for parameter identification of nonlinear material constitutive models utilizes the global force and displacement boundary loadings that are experimentally identified to globally search for initial constitutive parameters using a genetic algorithm. The initially identified constitutive parameters are then iteratively optimized by a simplex method in which two nonlinear finite element analyses are conducted in parallel using updated material constitutive parameters under the experimentally measured force and displacement boundary loadings. Stress and strain values for both the force and displacement finite element analyses are then input into an implicit objection function. Finally, the simplex optimization is performed for a number of predetermined number of iterations, whereupon the start of each new iteration utilizes the previously optimized set of constitutive parameters.

### CROSS-REFERENCE TO RELATED APPLICATION

This application claims the benefit of U.S. Provisional Application No. 61/590,044 filed on Jan. 24, 2012, the contents of which are incorporated herein by reference.

### TECHNICAL FIELD

Generally, the present invention relates to a method of identifying parameters of material constitutive models. In particular, the present invention is directed to a method of identifying parameters of nonlinear material constitutive models. More particularly, the present invention is directed to a self-optimizing, inverse method of identifying parameters of nonlinear material constitutive models.

### BACKGROUND ART

Due to the increased processing power of computers, complex nonlinear constitutive models have become a feasible method for identifying the manner in which a particular material or structure reacts to a loading during the design stage of complex structures that utilize such materials. Most material constitutive models contain either physical or phenomenological parameters of the modeled material that initially require calibration based on experimental observations of the physical behavior of the material in response to a loading. However, as the number of parameters in the material constitutive model increases, it becomes more difficult to determine the values of such parameters due to the limited availability of laboratory test data, and due to the overall lack of information relating to the behavior of the modeled material itself. Therefore, robust inverse methods for identifying material constitutive model parameters from observed experimental test data are highly desirable for the achievement of enhanced predictions of the in-situ response of a modeled material.

Currently, there are a plurality of inverse identification methods for identifying material constitutive model parameters, including a finite element model updating (FEMU) method, and a virtual field method (VFM). Such constitutive parameter identification methods enforce equilibrium conditions, either in weak or strong form, as well as enforce constitutive relationships that relate full-field displacements to the stresses and boundary conditions. However, such inverse methods for identifying material constitutive model parameters differ in the objective functions they use, and also differ as to whether they require the measurement of full-field displacements or not.

The FEMU method or finite element model updating method, is an updating-based method, which iteratively updates the constitutive parameters, thereby minimizing an objective function that represents the error, or gap, such as displacement gaps, constitutive equation gaps, and equilibrium gaps for example, between the measured quantity and the corresponding quantity that is computed using finite element analysis. The FEMU approach has been applied to model parameter identification for materials with linear elastic, viscoelastic, elasto-plastic, and viscoplastic behavior. The FEMU method may not require full-field measurements, as partial measurements may be sufficient to determine the constitutive parameters. However, the FEMU method requires iterative finite element analyses, which requires a substantial amount of computational time of the computer system that is performing the finite element analysis.

Continuing, the VFM or virtual field method, utilizes a chosen set of kinematically admissible virtual displacement fields that are assumed and that are substituted into a virtual work equation along with full-field displacement data that is measured by a digital image correlation (DIC) technique. As such, the VFM method leads to a system of linear equations that can then be solved to identify the material constitutive parameters.

However, while the VFM method has the advantage of faster computation times over that provided by the FEMU approach, the VFM method requires full-field measurements, which requires costly equipment. Moreover, digital image correlation (DIC) based full-field displacement data utilized by the VFM method are subject to potential measurement errors. In addition, the DIC technique has been combined with finite element (FE) simulations to identify key parameters in a material constitutive model.

As an alternative to the VFM and the FEMU methods, an auto-progressive training method was developed that enables artificial neural network (ANN) based material models to be automatically trained through nonlinear finite element analyses under boundary force and displacement measurements that are acquired from experimental laboratory tests. As such, the auto-progressive training analysis method is able to extract local constitutive behavior from the ANN-based models that are derived from only the global response that is observed in laboratory testing. However, because this method of parameter estimation is restricted to ANN-based material constitutive models, it is limited in its usefulness.

Therefore, there is a need for a method of identifying constitutive model parameters independently of the type of material constitutive model being analyzed. In addition, there is a need for a method of identifying constitutive model parameters that is able to identify such constitutive model parameters solely on experimental global measurements of boundary forces and displacements. In addition, there is a need for a method of identifying constitutive model parameters without the use of digital image correlation (DIC) based full-field displacement data. Furthermore, there is a need for a method of identifying constitutive model parameters that is simple to implement with a variety of global optimization tools, such as genetic algorithms or gradient-free simplex methods. Still yet, there is a need for a method of identifying constitutive model parameters that requires reduced computational times.

### SUMMARY OF THE INVENTION

In light of the foregoing, it is a first aspect of the present invention to provide a self-optimizing, inverse analysis method for parameter identification of nonlinear constitutive models.

Another aspect of the present invention is to provide a self-optimizing, inverse analysis method for parameter identification comprising inputting a material constitutive model into a computer system, the material constitutive model having at least one material constitutive parameter to be identified; identifying only a boundary force loading value and a boundary displacement loading value of a material; generating at least one initial constitutive parameter associated with the constitutive model at the computer system based on the identified boundary force loading value and the boundary displacement loading value; performing a displacement-driven nonlinear finite element analysis and a force-driven nonlinear finite element analysis in parallel of the at least initial constitutive parameter, to respectively generate a set of displacement-driven stress and strain values and a set of force-driven stress and strain values; minimizing the error between the set of displacement-driven stress and strain values and the set of force-driven stress and strain values; and updating the at least one initial constitutive parameter based on the minimizing step; wherein the performing step, the minimizing step, and the updating step are repeated for a predetermined number of iterations input at the computer.

### BRIEF DESCRIPTION OF THE DRAWINGS

These and other features and advantages of the present invention will become better understood with regard to the following description, appended claims, and accompanying drawings wherein:

FIGS. 1A-C is a graphical view showing the effect of combined nonlinear isotropic and kinematic hardening of a cyclic hardening response;

FIG. 2 is a flow diagram showing the operational steps taken to carry out a Self-OPTIM inverse analysis method in accordance with the concepts of the present invention;

FIG. 3A is a top plan view showing the geometry of a dog-bone shaped material test specimen used to validate the Self-OPTIM method in accordance with the concepts of the present invention;

FIG. 3B is a finite element (FE) mesh diagram of the dog-bone shaped material test specimen of FIG. 3A for validating the Self-OPTIM method in accordance with validation tests in accordance with the concepts of the present invention;

FIG. 3C is a top plan view showing the geometry of a notched shaped material test specimen used to validate the Self-OPTIM method in accordance with validation tests of the present invention;

FIG. 3D is a finite element (FE) mesh diagram of the notched shaped material test specimen of FIG. 3C in accordance with validation tests of the present invention;

FIGS. 4A-D are charts showing the mean value and standard error of the identified constitutive parameters in homogeneous and heterogeneous tests in accordance with the concepts of the present invention;

FIG. 5 is a graph showing a comparison of the force-displacement curves that are reconstructed by using the constitutive parameters prior to utilizing the Self-OPTIM method of the present invention; after the self-OPTIM method of the present invention; and the experimental data in accordance with the concepts of the present invention;

FIG. 6A is a graph showing a reconstructed force-displacement curve of the dog-bone specimen by the parameter set identified by the notched shaped material specimen in accordance with the concepts of the present invention;

FIG. 6B is a graph showing a reconstructed force-displacement curve of the notched specimen by the constitutive parameter set identified from the dog-bone shaped material specimen in accordance with the concepts of the present invention;

FIGS. 7A-D are graphical representations of stress and strain distributions of the notched specimen along a longitudinal direction at 150^{th} load step that are compared between force-driven and displacement-driven analyses by using an initial parameter set and an identified parameter set in accordance with the concepts of the present invention; and

FIGS. 8A-F are plots of normalized longitudinal stresses and strains of a notched specimen from force-driven and displacement-driven simulations using a parameter set prior to Self-OPTIM (FIGS. 8A-B), at the 5^{th} optimization iteration (FIGS. 8C-D), and after the Self-OPTIM method has been carried out (FIGS. 8E-F) in accordance with the concepts of the present invention.

### DETAILED DESCRIPTION OF THE INVENTION

The present invention comprises a self-optimizing inverse analysis method (Self-OPTIM) for the identification of parameters of any suitable material constitutive model. That is, the method contemplated herein can be carried out independently of the type of constitutive model being utilized. For the purposes of the following discussion, the Self-OPTIM method is used to identify parameters of a cyclic plastic constitutive model having a nonlinear kinematic hardening law that simulates the inelastic behavior of a material under cyclic loadings.

In order to carry out the Self-OPTIM method contemplated by the present invention to identify the constitutive parameters of the cyclic plastic constitutive model, a user material model subroutine (UMAT) is implemented. The chosen elasto-plasticity constitutive model represented by the UMAT subroutine can reproduce both nonlinear isotropic and kinematic hardening behavior, which is commonly observed in metallic materials, but is not limited thereto. Specifically, the associate plastic flow rule under a normality hypothesis assumes that plastic strain increases in a direction that is normal to the yield surface. A fundamental assumption in plasticity theory is the decomposition of the total strain rate into elastic and plastic parts, where they are expressed as:

$$d E = d {E}^{e} + d {E}^{p} ; d {E}_{ij}^{p} = d λ \frac{\partial f}{\partial {S}_{ij}} ,$$

where dλ is the plastic multiplier. In the radial return method, the trial deviatoric stress increment takes a stress state to the outside of the yield surface, while the plastic corrector brings the stress state back onto the yield surface in the radial direction. Further, on the π plane, the von Mises yield locus takes a circular form. The multi-axial yield functions is expressed as follows:

$$\begin{matrix}F ( S ) = {S}_{e}^{tr} - r - {S}_{y} = 0 & ( 1 ) \\ {S}_{e}^{tr} = \sqrt{\frac{3}{2} ( {S}_{ij}^{tr\_dev} - {α}_{ij} ) ( {S}_{ij}^{tr\_dev} - {α}_{ij} )} & ( 2 )\end{matrix}$$

where Sᵢⱼ^{tr}^{_{—}}^{dev} the trial deviatoric stress component; αᵢⱼ is the back stress for nonlinear kinematic hardening; S_{y} is the yield stress; and r is the drag stress for isotropic hardening behavior. The yield function is a nonlinear function of the effective plastic strain. Thus, Newton's iterations should be executed to find the plastic strain increment, which is expressed as: ΔE^{p}=Δpn where

$$n = \frac{3}{2} ( \frac{{S}^{dev} - {α}_{t}}{{S}_{e}^{tr}} ) ,$$

such that n is the normal direction tensor; Δp is the increment of effective plastic strain; S^{dev} is the deviatoric stress tensor; αᵢ is the back stress at the previous converged state time t; and Sₑ^{tr} is the effective trial stress.

### Effects of Hardening Parameters on Cyclic Elasto-Plastic Behavior of Materials

For the kinematic hardening behavior, the Amstrong-Frederick type model (A-F model) is used for simulating evolutions of the back stress under cyclic loadings. However, it is known that the model has limitations in reproducing ratcheting response of the material and the decomposed nonlinear kinematic hardening models can better predict stresses under cyclic loadings than the conventional A-F model. To reproduce the Bauschinger effect, the A-F model defines an evolutionary equation of the back stress as follows:

\dot{α}ᵢₘ=2/3Cnᵢⱼ\dot{p}−γαᵢⱼ\dot{p} (3).

As the effective plastic strain increment (\dot{p}) increases, the rate of the back stress (\dot{α}ᵢⱼ) also increases. In addition, nᵢⱼ is a component form of the normal direction tensor (n). Two specific kinematic model hardening parameters C and γ determines the maximum saturated yield stress (C/γ) along the kinematic hardening evolution and γ influences the rate of saturation of the yield stress due to kinematic hardening. Considering such effects of the C and γ parameters on the kinematic hardening and translational evolutions of the yield surface in stress space, at least a half-cycle (loading-yielding-unloading-yielding) stress-strain path with a sufficiently large strain range is required to identify the parameters.

A nonlinear isotropic hardening model is adopted to simulate expansion of the yield surface under increasing plastic deformations. The rate equation of the isotropic hardening parameter is expressed as:

\dot{r}(p)=b(Q−r)\dot{p} (4).

Specifically, Eq. 4 defines, r as the drag stress showing isotropic hardening behavior; Q determines the saturated yield stress (Q+S_{γo}) to be reachable during cyclic straining; and the value of b determines the rate of the saturation of the yield stress. Eq. (4) is expressed as r(p)=Q(1−e^{-bp}) if integrated with initial value r=0. Thus, depending on the strain range and the parameter b, local stress-strain paths could be sufficient or insufficient for identifying the parameter Q. Under symmetric stress or strain, controlled experiments of metallic materials are performed to identify both the isotropic and kinematic hardening effects, which are combined to generate the cyclic hardening behavior.

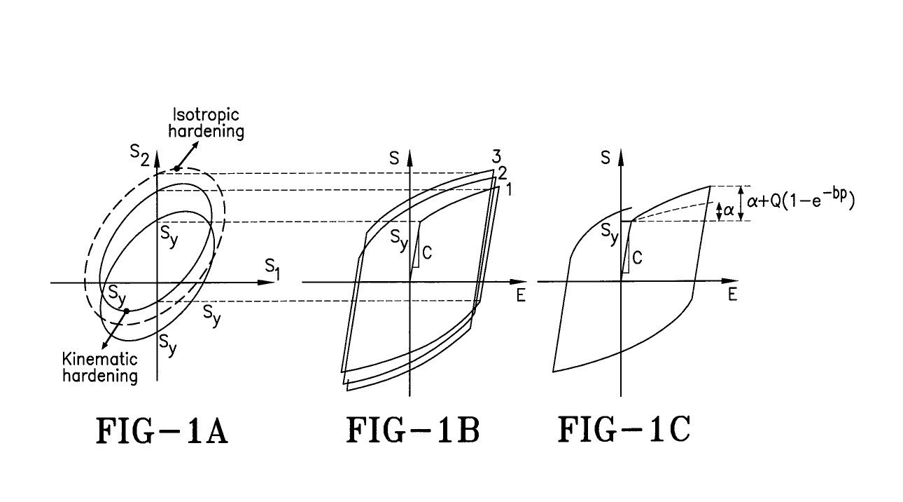

FIGS. 1A, 1B, and 1C show the effect of combined linear isotropic and kinematic hardening on the cyclic hardening response. According to this observation, multiple cycles of stress-strain paths experienced by the material can provide comprehensive information to identify the hardening parameters.

As long as sufficient stress-strain data within the linear elastic range are generated, Young's modulus (E) and Poisson ratio could also be identified. Since error of the initial yield stress can create large errors in subsequent stress updates, the yield stress can be identified as long as the material is yielded. However, due to limitations of the testing machine and the geometry of specimens used, the loading and half of the unloading path that was under tension stress states were used as the basis of the discussion presented herein, in order to avoid buckling during material tests. Thus, only nonlinear hardening was activated for the purposes of the following discussion.

### Compatibility of the Self-OPTIM Inverse Analysis Method

The Self-OPTIM method of the present invention is provided to identify parameters of material constitutive models, and requires only global force and displacement boundary loadings that are measured from experimental laboratory tests. Such a feature of the Self-OPTIM method is highly desirable, as digital image correlation (DIC) based full-field displacements required by other parameter identification methods are always subjected to measurement and computation errors. Thus, because such DIC displacements are not required by the Self-OPTIM method of the present invention, the parameter identification process contemplated herein is more efficient than other parameter identification methods that require full-field displacement measurements, such as the VFM method for example. Furthermore, because computing DIC full-field displacements requires additional time, the Self-OPTIM method of the present invention is able to save computational time, thus accelerating the constitutive parameter identification process. Unlike the FEMU approach that directly compares the observable response for experiments and the finite element (FE) simulations, the Self-OPTIM method of the present invention minimizes an objective function (OF) that is defined in terms of full-field stresses and strains that are extracted through a course of two parallel nonlinear finite element simulations along a loading curve.

### Computational Procedures for the Self-OPTIM Inverse Analysis Method

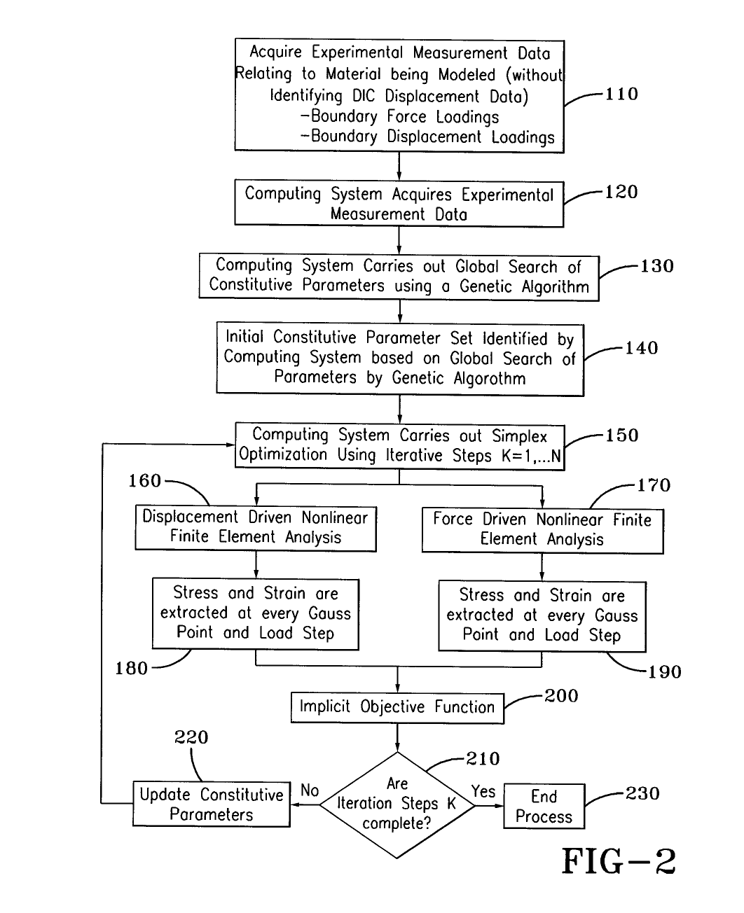

The operational steps for carrying out the Self-OPTIM method are generally referred to by the numeral 100, as shown in FIG. 2 of the drawings. Specifically, the operational steps 100 of the Self-OPTIM method may be carried out by any suitable computing system, such as a personal computer, for example. Initially, at step 110, the target or subject material is tested under a predefined cyclic loading profile. For example, in one aspect, the material tests may comprise any suitable test, including but not limited to tension, compression, and torsion tests, as well as more complex multi-axial tests, as long as well-defined boundary forces and displacements can be properly measured. Thus, the experimental process carried out at step 110 results in the acquisition of boundary force loading measurement data and boundary displacement loading measurement data. In another aspect, it is recommended that the loading paths be determined based on the constitutive parameters to be identified and based on the understanding of the effects of the parameters on stress predictions. It should also be appreciated that step 110 is performed without the identification of any digital image correlation (DIC) based displacement data, which is desirable.

Next, at step 120 the acquired measurement data regarding the target material for which constitutive parameters are being acquired are input into a computer system. It should be appreciated that the computer system may comprise any suitable computing system, such as a desktop or handheld computer for example.

Continuing, the computing system utilizes a hybrid genetic-simplex method to globally search for the optimal constitutive parameters, as indicated at step 130. The optimization technique used in the Self-OPTIM framework is a combination of a genetic algorithm (GA) and a simplex method. Initially, a total of 200 individuals are randomly generated by the computing system to form an initial population within feasible bounds. After the implicit objective function (OF_{implicit}) is evaluated for all individuals, the individual solution that gives the minimum objective function (OF_{implicit}) value is selected as an initial search guess by the computing system for performing the subsequent simplex method. Thus, the process carried out at step 130 first searches the solution space globally using a genetic algorithm or any other suitable global search tool, whereupon an initial constitutive parameter set is identified, as indicated at step 140. For example, at step 140 various initial constitutive parameters, such as Young's modulus (E), yield stress (σ_{γ}), and various parameters, C and γ, associated with the kinematic hardening law of the cyclic plastic constitutive model are identified. Next, the process 100 continues to step 150 where an optimization process is initiated using the simplex method that utilizes the reasonable initial inputs from step 140 carried out by the computing system. As a result, step 150 reduces the possibility of the optimization iterations being trapped to a local minimum. The maximum number of iterations (k) is set as a terminating criterion, whereby the simplex searching sequence is terminated when the preset maximum iteration number is reached.

Within each iterative step of the optimization process initiated at step 150, the computer system computes, in parallel, a displacement driven finite element analysis, as indicated at step 160 and a force driven finite element analysis, as indicated at step 170. The finite element analyses carried out at steps 160 and 170 by the computer system are performed using updated material constitutive model parameters under the experimentally measured force and displacement boundary loadings. Thus, the displacement-driven non-linear finite element (FE) simulation executed by the computing system computes stresses (σ_{U}) and strains (ε_{U}) at every Gauss point and load step, as indicated at step 180, while the force-driven nonlinear finite element (FE) simulation executed by the computing system computes stresses (σ_{F}) and strains (ε_{F}) at every Gauss point and load step, as indicated at step 190.

Once the stresses and strains are computed at steps 180 and 190, the computing system then utilizes an implicit objective function, as indicated at step 200, that is defined as a function of computed stresses (σ_{F}, σ_{U}) and strains (ε_{F}, ε_{U}). Specifically, the objective function is denoted as:

$${OF}_{implicit} = \frac{1}{2} \cdot {\sum }_{k = 1}^{LS} {[ 1 - \frac{{\sum }_{j = 1}^{NE} {\sum }_{i = 1}^{GP} {‖ {σ}_{iU}^{k} ‖}_{j}}{{\sum }_{j = 1}^{NE} {\sum }_{i = 1}^{GP} {‖ {σ}_{iF}^{k} ‖}_{j}} ]}^{2} + \frac{1}{2} \cdot {\sum }_{k = 1}^{LS} {[ 1 - \frac{{\sum }_{j = 1}^{NE} {\sum }_{i = 1}^{GP} {‖ {ɛ}_{iF}^{k} ‖}_{j}}{{\sum }_{j = 1}^{NE} {\sum }_{i = 1}^{GP} {‖ {ɛ}_{iU}^{k} ‖}_{j}} ]}^{2} , \qquad ( 7 )$$

where ∥ ∥ indicates a Euclidean norm; σ_{iF}^{k}, ε_{iF}^{k}, σ_{iU}^{k}, ε_{iU}^{k} identify the simulated stresses and strains that are extracted or otherwise computed by the computer system at steps 180 and 190 from the zone of interest (ZOI) under displacement and force boundary conditions, respectively. Moreover, terms LS, NE, and GP in the objective function OF_{implicit} respectively represent the total number of selected load steps to be taken, the total number of selected elements in the zone of interest (ZOI), and the total number of Gauss points in the finite elements. Self-OPTIM has flexibility in selecting a zone of interest (ZOI) where the information regarding stresses and strains is sufficient enough to identify material related parameters. The flexibility enables exclusion of boundary regions where stresses and strains could be potentially non-uniform unlike loadings on finite element (FE) models. Owing to the Saint-Venant's principle, stress distributions will become boundary-effect-free at the location away from the boundary. Based on material geometries, expected stress distributions and intensities, the zone of interest ZOI can be determined.

Specifically, at step 200, the objective function OF_{implicit} is evaluated whereby a total of 200 individuals are randomly generated to form an initial population within feasible bounds. After the objective function OF_{implicit} is evaluated for all individuals, the individual solution giving the minimum OF_{implicit} value is selected as an initial guess for the subsequent simplex method. As such, the constitutive parameter set is then updated, and the process 100 determines whether the iterations of the simplex method have been completed at step 210. If at step 210, the iterations are not complete, then the process continues to step 220, where the currently updated constitutive parameter set (Young's modulus (E), yield stress (σ_{γ}), C, and γ) is then further optimized by repeating steps 150-210. That is, the process 100 initially defines the constitutive parameters based on a global search of the constitutive parameters by a genetic algorithm at step 140, and then is followed by optimization iterations, at steps 150-210 using the simplex method with a reasonable initial input. Therefore, the process 100 reduces the possibility of being trapped at a local minimum. Finally, the maximum number of iterations is set as a terminating criterion, and therefore the simplex searching will be terminated when the preset maximum iteration number is reached.

However, if at step 210, the process 100 determines that the preset number of iterations of the simplex method is complete, the process 100 continues to step 230, whereupon it ends.

A fundamental difference between the Self-OPTIM method 100 and other inverse identification methods is that experimental measurements of displacement, force, and various other material responses are not used as reference values in the self-OPTIM method 100. Instead, those experimental measurements of displacement, force, and other material responses serve as predefined boundary loadings for the two parallel nonlinear finite element (FE) simulations that are carried out in parallel at steps 160 and 170 of the process 100. Moreover, DIC based full-field displacements are not required by the contemplated Self-OPTIM method.

Verification of Self-OPTIM Method with Experimental Test Results

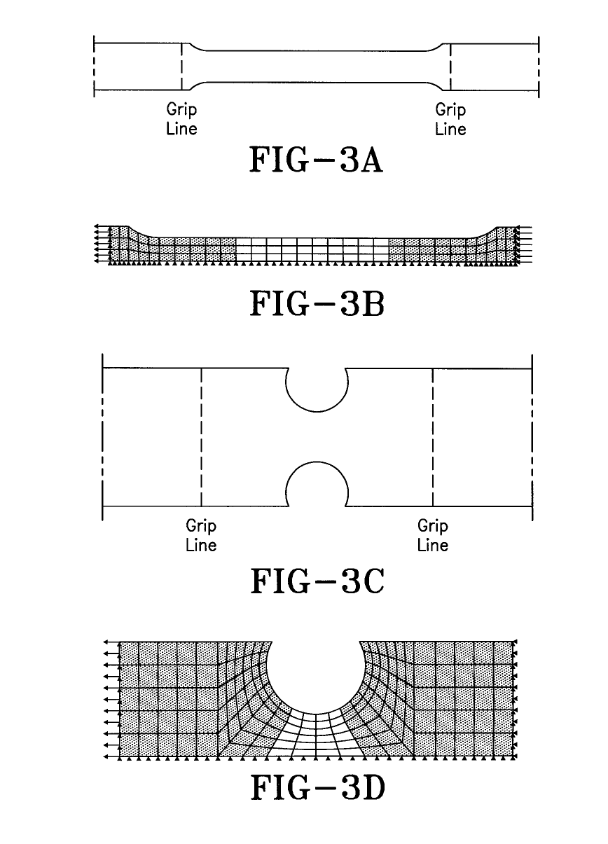

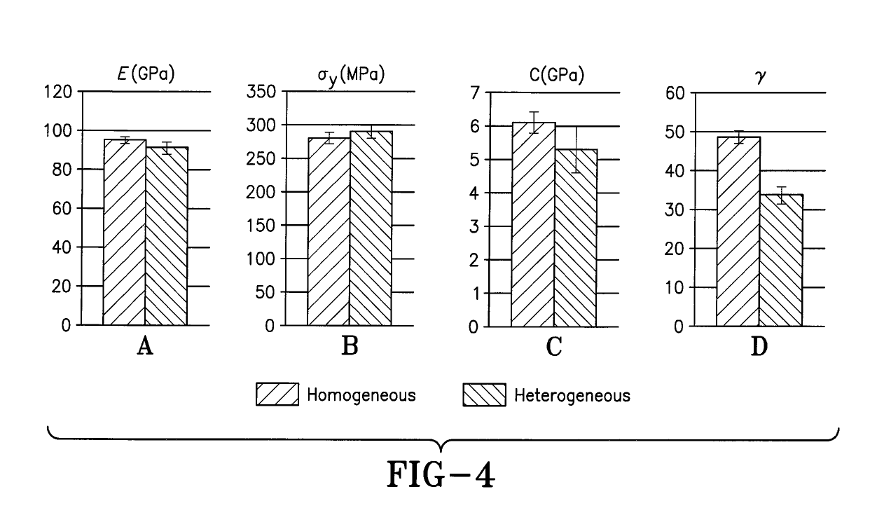

In order to verify the Self-OPTIM method 100 contemplated herein, experimental tests were performed using two types of test material specimens: a dog-bone specimen 400, as shown in FIG. 3A, for a homogeneous stress test, and a notched specimen 410, as shown in FIG. 3B, for a heterogeneous stress test. Three specimens of each type (dog-bone and notched) were cut from the same plate of material having a 2 mm thickness. Specifically, the geometric dimensions of the specimens 400 and 410 are shown in FIGS. 3A and 3C, while the corresponding finite element (FE) models using eight-node plane stress elements are shown in respective FIGS. 3B and 3D of the drawings. Displacement-controlled uni-axial tension loading and unloading tests were carried out in the Y direction by an INSTRON® material test machine at a quasi-static strain rate of 1.5×10⁻⁵.

During the homogeneous stress test, each of the three dog-bone specimens 400 were loaded up to a maximum displacement of 4.318 mm and unloaded to 4.064 mm. In the heterogeneous stress tests, each of the three notched specimens 410 were loaded up to a maximum displacement of 2.032 mm and unloaded to 1.778 mm. The displacement and force data were recorded at a sampling frequency of approximately 5 Hz. Data of the full loading path can be divided into three parts, including linear elastic, plastic deformation, and linear unloading regions. Due to measurement noise, the experimental force-displacement data was curve-fitted before it was utilized in the self-OPTIM method 100. Approximately 200 load steps of data (pairs of displacement and force data) were resampled for use in two parallel, non-linear finite element (FE) simulations of the Self-OPTIM process 100. When applying the boundary forces to the finite element (FE) model, it is assumed that the boundary force is imposed as uniformly distributed along the gripped line. A group of white-colored elements, as indicated in FIGS. 3B and 3D was selected as a zone of interest (ZOI) from which stresses and strains were extracted during the Self-OPTIM identification method 100.

It must be noted, however, that data in the plastic regime of the unloading course was not included in the predefined boundary loading because the test data included the geometric softening effect due to buckling under compression in addition to the effect of pure material deformation. According to the reproduced experimental force-displacement curve by nonlinear finite element (FE) simulations with the identified parameters, it could be judged that the identified parameters could be very different from the feasible parameters. Therefore, it is important when conducting the Self-OPTIM process 100 that no geometric softening effects be included in the predefined boundary loading data (i.e. reference data).

### Parameter Identification Results

A total of six Self-OPTIM inverse analyses were conducted to identify the constitutive model parameters of the cyclic plastic model, whereby three Self-OPTIM analyses were used for the dog-shape specimens 400 and three Self-OPTIM analyses were used for the notched specimens 410. Good convergence was observed in all of the Self-OPTIM inverse analyses method 100. Identification results of the unknown parameter set are summarized in Table 1 and Table 2 that follow.

TABLE 1
Identification results from the Self-
OPTIM method for dog-bone specimens

| | Dog-bone Specimen | | | | Standard |
|---|---|---|---|---|---|
| | 1 | 2 | 3 | Mean | Error |
| E(GPa) | 92.582 | 95.430 | 97.450 | 95.154 | 1.412 |
| σ_{y} | 276.604 | 295.633 | 268.254 | 280.164 | 8.102 |
| C(GPa) | 6.618 | 5.528 | 6.197 | 6.114 | 0.317 |
| γ | 51.251 | 45.591 | 48.801 | 48.548 | 1.638 |

TABLE 2
Identification results from the Self-
OPTIM method for notched specimens

| | Notched Specimen | | | | Standard |
|---|---|---|---|---|---|
| | 1 | 2 | 3 | Mean | Error |
| E(GPa) | 88.804 | 87625 | 97.471 | 91.300 | 3.104 |
| σᵥ | 305.052 | 291.531 | 272.329 | 289.637 | 9.494 |
| C(GPa) | 4.188 | 5.146 | 6.573 | 5.302 | 0.0.693 |

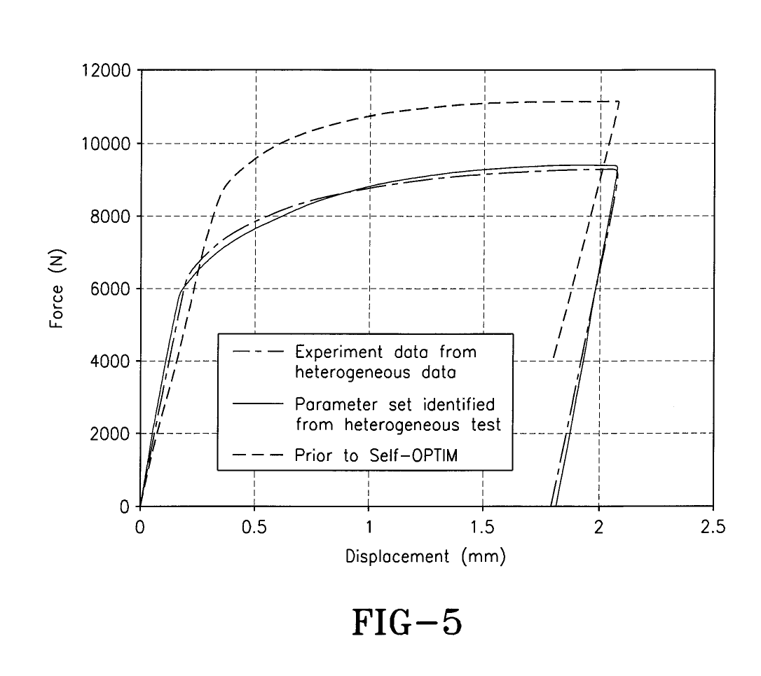

The mean value and the standard error (standard error=σ/n^{1/2} where σ is the standard deviation and n is the number of samples) of each identified constitutive parameter are shown in FIGS. 4A-D. Thus, the identified constitutive parameters of the cyclic plastic model have good agreement with each other in both the dog-bone and notched specimen types 400 and 410. The six force-displacement curves were reconstructed using nonlinear finite element (FE) simulations in which the constitutive model parameters identified by Self-OPTIM were used. When compared with the corresponding curves from experimental tests, all of them were observed to be identical. Verification results of the first notched specimen 410 are shown in FIG. 5. Therefore, it was demonstrated that the Self-OPTIM method 100 was able to identify the constitutive parameter set, which can represent the experimental data accurately.

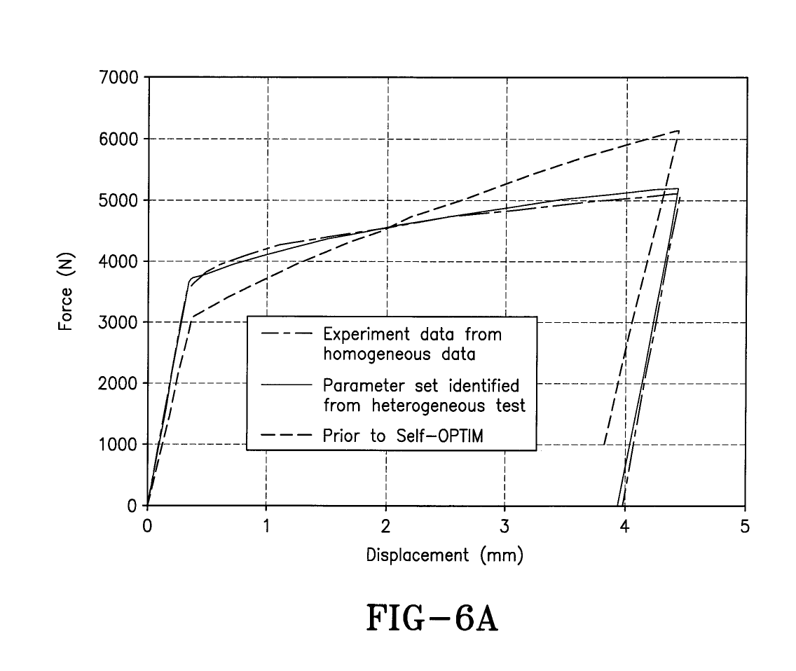

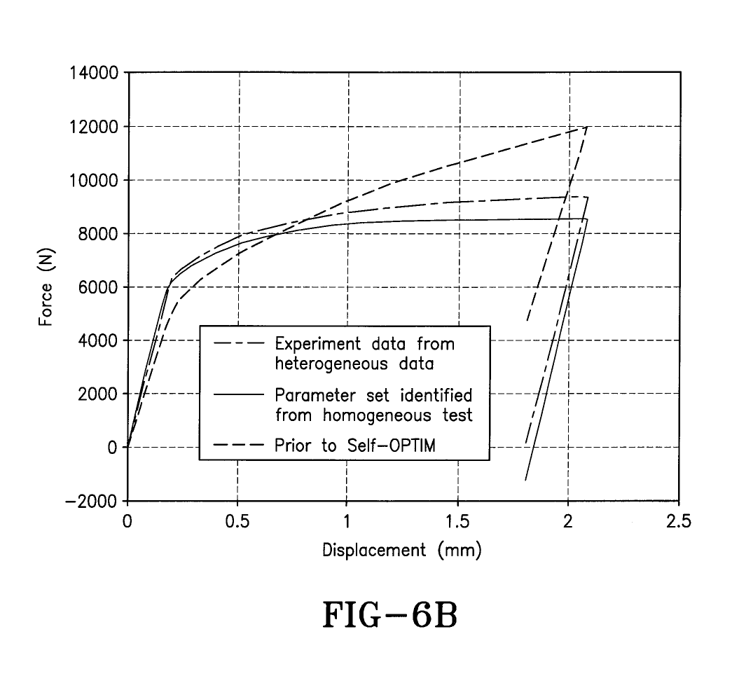

To further examine the constitutive parameter identification results using the Self-OPTIM method 100, two simulations were conducted for cross comparisons in which the mean values of the cyclic parameters identified from dog-bone shape specimens 400 were used to predict the force-displacement response of notched specimens 410 and vice versa. Because the specimens 400 and 410 are made of the same material, the force-displacement curves are expected to be identical in an ideal case. However, slight discrepancies between the reconstructed curves shown in FIGS. 6A-B are attributable to the stochastic process associated with the materials used to form the specimens 400 and 410. First, considering the stochastic process in detail, it must be noted that the material forming the specimens 400 and 410 has inherited variability; as every material point has different material properties. Secondly, the pre-hardening of the material caused by the manufacturing process of the material may be different between the dog-bone specimens 400 and notched specimens 410. This could lead to different yield stresses and hardening behavior in each of the two specimen types 400 and 410. Finally, the modeling error caused by gripping is inevitable in each test, as it is difficult to exactly align the grip position of the specimens 400 and 410 in the lab to that of the finite element (FE) model.

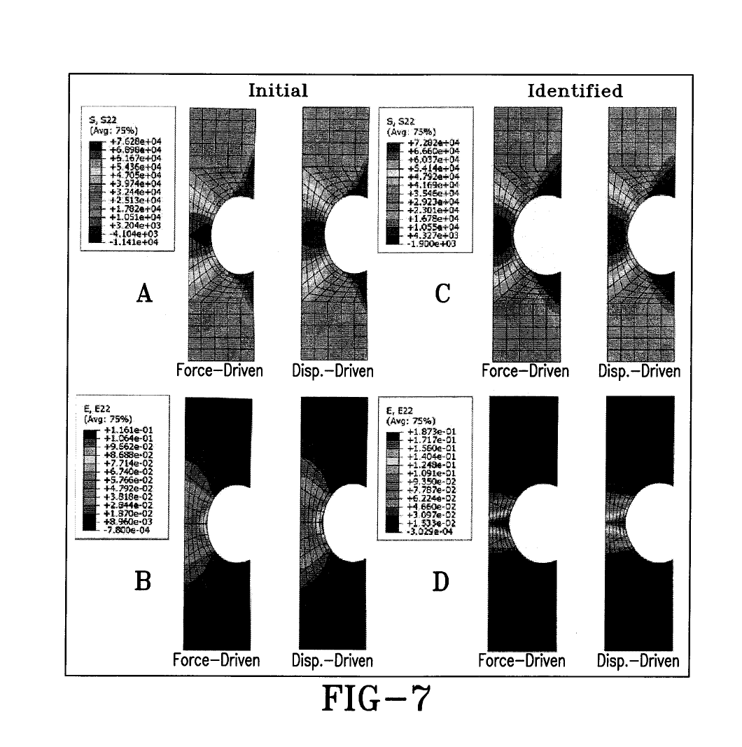

In order to show the progress of self-calibration by the Self-OPTIM method 100, FIGS. 7A-D show the stress and strain distribution from the force-driven and displacement-driven simulations by using the initial parameter set (FIGS. 7A-B) and an identified parameter set (FIGS. 7C-D) at a certain load steps. As such, it can be observed that correlation of stresses and strains between two parallel simulations significantly increases after the Self-OPTIM process 100 is performed.

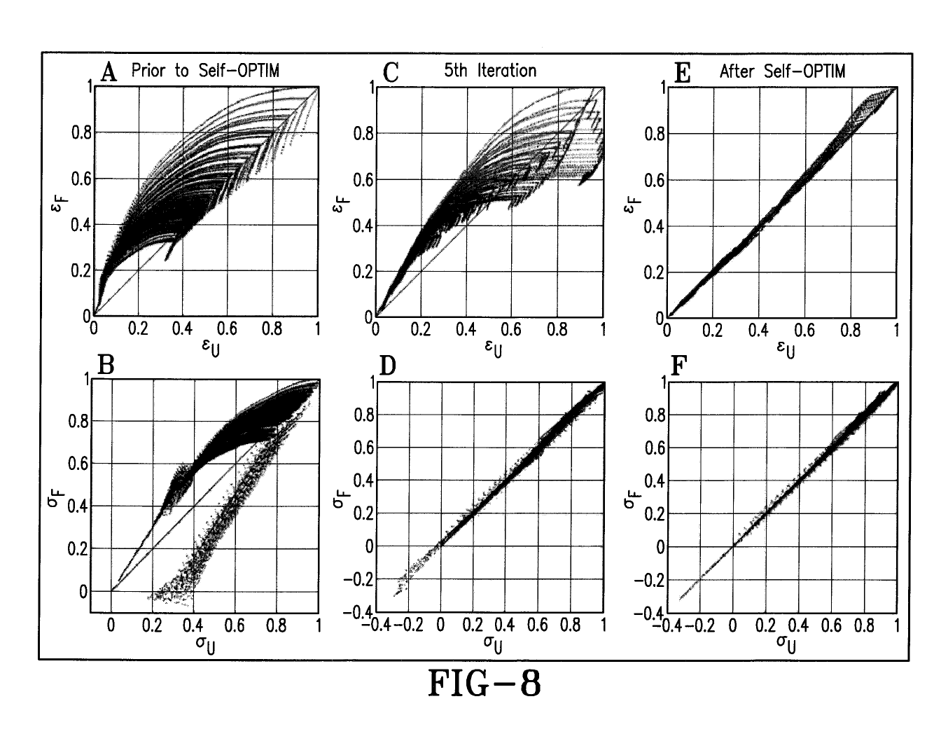

Normalized longitudinal stresses and strains extracted from the force-driven and displacement-driven simulations of the notched specimen 410 were plotted at different stages of Self-OPTIM analyses, as shown in FIGS. 8A-F. First, a constitutive parameter set prior to the utilization of the Self-OPTIM process 100 was used in the simulations. As shown in the first column of FIGS. 8A-B, the stresses σ_{F} and strains ε_{F} simulated under two boundary loading conditions were very different. After five iterations of the Self-OPTIM process 100, the stresses σ_{F} and strains ε_{F} shown in FIGS. 8C-D have better agreements. Furthermore, the stresses σ_{F} and strains ε_{F} shown in FIGS. 8E-F become almost identical since the constitutive parameter set is sufficiently identified after the performance of the Self-OPTIM method 100. The correlation coefficient (R), root mean squared error (RMSE), and mean absolute error (MAE) of stresses and strains between force-driven and displacement-driven simulations at different iterative steps are calculated by the following Equations 8-10:

$$\begin{matrix}R = \frac{{\sum }_{n} ( {A}_{n} - \overline{A} ) ( {B}_{n} - \overline{B} )}{\sqrt{( {\sum }_{n} {( {A}_{n} - \overline{A} )}^{2} ) ( {\sum }_{n} {( {B}_{n} - \overline{B} )}^{2} )}} & ( 8 ) \\ R M S E = \sqrt{\frac{{\sum }_{n} {( {A}_{n} - {B}_{n} )}^{2}}{n}} & ( 9 ) \\ M A E = \frac{{\sum }_{n} \vert {A}_{n} - {B}_{n} \vert}{n} . & ( 10 )\end{matrix}$$

Specifically, Aₙ and Bₙ are two vectors that are to be compared, where the results of the comparison are shown in Table 3. As the optimization iteration proceeds, it was observed that the value R approaches one, and both the RMSE and MAE values decrease significantly.

TABLE 3
Statistic analysis of stresses and strains of a notched specimen
from force-driven and displacement-driven simulations

| | R | | RMSE | | MAE | |
|---|---|---|---|---|---|---|
| | σ | ε | σ | ε | σ | ε |
| Prior to Self- | 0.83618 | 0.89493 | 0.13622 | 0.14433 | 0.11511 | 0.12003 |
| OPTIM | | | | | | |
| 5^{th} Iteration | 0.99775 | 0.93077 | 0.01530 | 0.11163 | 0.01172 | 0.09385 |
| After Self- | 0.99882 | 0.99892 | 0.01281 | 0.01122 | 0.01005 | 0.00704 |
| OPTIM | | | | | | |

Based on the foregoing, one advantage of the present invention is that a self-optimizing method for parameter identification of nonlinear material constitutive models (Self-OPTIM) is able to be applied to constitutive models independently of their type, allowing the Self-OPTIM method to be applied to a wide range of applications to various engineering simulations. Yet another advantage of the present invention is that a self-optimizing method for parameter identification of nonlinear material constitutive models (Self-OPTIM) is simple to implement with a variety of global optimization tools, such as genetic algorithms or gradient-free simplex method. Still another advantage of the present invention is that a method for identifying parameters of material constitutive models (Self-OPTIM) requires only global force and displacement boundary loading values measured from laboratory tests to identify material constitutive model parameters. Yet another advantage of the Self-OPTIM method of the present invention is that it establishes a framework, such that parameters of a chosen material constitutive model are unknown a priori. Still another advantage of the Self-OPTIM method of the present invention is that an implicit objective function is expressed in terms of full-field stresses and strains from the two non-linear finite element analyses and is iteratively minimized. Another advantage of the Self-OPTIM method of the present invention is that constitutive model parameters can be identified without the use of digital image correlation (DIC) based full-field displacement data.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. method of parameter identification of a material constitutive model comprising:
inputting a material constitutive model into a computer system, said material constitutive model having at least one material constitutive parameter to be identified;
identifying only a boundary force loading value and a boundary displacement loading value of a material;
generating at least one initial constitutive parameter associated with said constitutive model at said computer system based on said identified boundary force loading value and said boundary displacement loading value;
performing a displacement-driven nonlinear finite element analysis and a force-driven nonlinear finite element analysis in parallel of said at least initial constitutive parameter, to respectively generate a set of displacement-driven stress and strain values and a set of force-driven stress and strain values;
minimizing the error between said set of displacement-driven stress and strain values and said set of force-driven stress and strain values; and
updating said at least one initial constitutive parameter based on said minimizing step;
wherein said performing step, said minimizing step, and said updating step are repeated for a predetermined number of iterations input at said computer.

2. The method of claim 1, wherein said generating step is performed using a genetic algorithm.

3. The method of claim 1, wherein said minimizing step is performed using an objective function.

4. The method of claim 3, wherein said objective function comprises an implicit objective function.

5. The method of claim 1, wherein said material constitutive model is nonlinear.
